(19) United States
(12) Patent Application Publication
(10) Pub. No.: US 2010/0155287 A1
(43) Pub. Date: Jun. 24, 2010

(54) POLAR ELEMENT FOR A PERMANENT MAGNET

(75) Inventor: Pauli Santala, Vanha-Ulvila (FI)

Correspondence Address: YOUNG & THOMPSON, 209 Madison Street, Suite 500, Alexandria, VA, 22314, US

(73) Assignee: NEOREM MAGNETS OY, Ulvila (FI)

(21) Appl. No.: 12/296,308

(22) PCT Filed: Apr. 5, 2007
(86) PCT No.: PCT/FI07/00086

§ 371 Date: Oct. 22, 2008

(30) Foreign Application Priority Data
Apr. 7, 2006 (FI) 20060340

(51) Int. Cl. B65D 45/00; F16B 2/24; B65D 90/02

(52) U.S. Cl. 206/524.1; 206/477; 206/521; 206/524.6; 220/324

(57) ABSTRACT

A polar element for a permanent magnet, includes at least one permanent magnet; a case structure, inside which the permanent magnet is placed; a fitting element adapted to be coupled to the case structure to seal the permanent magnet inside a sealed case formed by the case structure and the fitting element; and filling material inside the case for coupling the permanent magnet to the case structure and/or to the fitting element. Either the case structure or the fitting element is made of ferromagnetic material, the other one being made of non-magnetic material. Mechanically bendable flanges or protruding parts are formed in the case structure and/or the fitting element, and corresponding surfaces are respectively formed in the fitting element and/or the case structure, substantially opposing the flanges or protruding parts such that the flanges or protruding parts are bendable to the corresponding surfaces.

### FIELD OF THE INVENTION

The object of the invention is a polar element for a permanent magnet defined in the preamble of claim 1.

### BACKGROUND OF THE INVENTION

The object of this invention is a polar element with a casing containing at least one permanent magnet. Polar elements are used in permanent magnets, secured to the axis of permanently magnetized devices, such as electric motors and generator drives, to provide the necessary magnetic field. The aim of the polar element is to provide modularity to the structure used for providing the magnetic field, the elements of this modular structure being magnetable without the risk of breaking down, and being easily secured, when magnetized, successively and/or adjacently to the outer surface of the axis. The permanent magnet's polar element should be protected from corrosion as effectively as possible by coating and by casing to protect from air. The polar element should endure mechanical stress, both tangential and radial, which is why magnets should be sealed, either merely mechanically or mechanically and by glue, regardless of the magnetic hold, to stay in place as firmly as possible.

The polar element unit consists of at least one permanent magnet, a case structure made of non-magnetic material, a base plate made of ferromagnetic material, and filling paste or glue. Traditionally, the polar element is composed such that an unmagnetized permanent magnet component is placed, using glue or other similar paste, on the base of the protective case or on the base plate. The steel base plate is then fitted on the permanent magnet glued in the protective case, or the protective case is fitted on the permanent magnet resting on the base plate. Finally, the strength of the structure is secured by coupling the protective case on the base plate with glue or screws or by welding. If coupling is made by gluing, then gluing itself and drying of the glue constitute separate phases. If coupling is instead made by welding, the welded seam must be protected against corrosion in a separate phase. Also the space underneath the welded seam between the protective case and the base plate must be free of glue or filling paste, which may prevent the formation of a tight welding seam. These additional phases render the manufacture of the polar element multiphase, slow and difficult to automatize.

### AIM OF THE INVENTION

The aim of the present invention is to eliminate the drawbacks of the prior art and to provide a better and easily manufactured polar element for a permanent magnet, the manufacture of which being easily automatized.

### SUMMARY OF THE INVENTION

The polar element for a permanent magnet according to the invention is characterized by what is disclosed in claim 1.

The polar element according to the invention, containing at least one permanent magnet, comprises a case structure, a fitting element to be coupled to the case structure, and filling paste, for rendering the polar element a substantially fully sealed object. For the functionality of the polar element, it is crucial that one or the other of the case structure of the polar element or the fitting element coupled thereto is made of non-magnetic material, the other one being made of ferromagnetic material.

According to the invention, mechanically bendable flanges or protruding parts are formed in the case structure and/or the fitting element, and corresponding surfaces are respectively formed in the fitting element and/or the case structure, substantially opposing the flanges and protruding parts, so that the flanges or protruding parts are bendable to the corresponding surfaces to interlock the case structure and the fitting element in such a way that the flanges or protruding parts, when bent, substantially remain within the external dimensions of the polar element.

The advantage of the invention is that the case structure and the fitting element may be mechanically interlocked, without using, in the manufacture of the polar element, any external coupling medium or external coupling elements. A further advantage is that, since the flanges and protruding parts do not extend over the external dimensions of the polar element, but remain, when in the bent coupling position, within the external dimensions of the polar element, the flanges and protruding parts do not increase the space required by the polar element, so that the polar elements may be placed closely and contiguously during storage, transportation and use, and fitted successively and/or adjacently. Also, as an advantage of the invention, the polar element is built significantly faster and the manufacture thereof is easily automatized.

In one embodiment of the polar element, the polar element is preferably formed as a rectangular prism, in which the two largest outer surfaces opposing each other are substantially squares. The case structure of the polar element is preferably so formed, that the case structure itself comprises one square outer surface and four other outer surfaces of the rectangular prism. The fitting element to be coupled to the case structure thus comprises only the other square outer surface of the rectangular prism. The case structure of the polar element and the fitting element coupled thereto may also be formed such that the fitting element coupled to the case structure comprises, in addition to the other square surface, at least one other outer surface of the rectangular prism, in which case the case structure of the polar element lacks the respective outer surface/s. The polar element according to the invention may also be formed as a cube, for example, in which case all six outer surfaces are squares, or a rectangular prism, in which all outer surfaces are rectangles. In these forms of the polar element, the fitting element coupled to the case structure may also comprise one or more of the outer surfaces of the polar element.

When manufacturing the polar element according to the invention, the flanges or protruding parts used for interlocking the case structure of the polar element and the fitting element are formed either in the case structure, or in the fitting element to be coupled to the case structure, or also alternatively in both. The corresponding surfaces for the flanges and protruding parts are preferably formed, for example, if the case structure of the polar element comprises four outer surfaces, which are set to contact the fitting element to be coupled to the case structure, by forming a flange, for example by cutting, on the corners of these outer surfaces, which are set to contact the fitting element to be coupled to the case structure. Grooves functioning as corresponding surfaces for the flanges are respectively formed, for example by cutting or drilling, on the corners of the fitting element to be coupled to the case structure, in which grooves the flanges in the case structure are bendable so that the flanges remain, in the final polar element, within the external dimensions of the polar element formed by the case structure and the fitting element to be coupled thereto.

In one embodiment of the polar element, the flanges or protruding parts used in the polar element to interlock the case structure and the fitting element to be coupled thereto, and the corresponding surfaces for the flanges and protruding parts may also be formed, instead of or in addition to placing them in the corners, in other parts of the contact surface between the case structure and the fitting element to be coupled thereto. Also, one way of interlocking the case structure and the fitting element to be coupled thereto is to use at least protruding parts coupled to the fitting element to be coupled to the case structure, and grooves formed in the case structure, or respectively, to use at least protruding parts coupled to the case structure and grooves formed in the fitting element to be coupled to the case structure. The flanges or protruding parts used in one embodiment of the polar element are preferably at least partly wedge-shaped, formed for example as a truncated wedge. The flanges or protruding parts may also be, at least partly, for example substantially circular, oval-shaped, triangular or quadrangular. The bending direction to the interlocking position of the flanges or protruding parts may be either inwards or outwards, with regard to the centre part of the polar element for a permanent magnet according to the invention, depending on the position of the corresponding surfaces.

If flanges, formed in the corners of the case structure, which corners are set to contact the fitting element to be coupled to the case structure, are used in the polar element to interlock the case structure and the fitting element to be coupled thereto, the flanges are then preferably sized such that the flanges bent in the same groove of the fitting element to be coupled to the case structure are preferably, when in the bent position, at least partially superpositioned with regard to each other.

When manufacturing the polar element for a permanent magnet according to the invention, if the case structure of the polar element contains both the square outer surface and four other outer surfaces of the rectangular prism, described above as a preferred embodiment, the component used as the case structure is preferably provided of a flat object, in which the flanges, necessary for interlocking according to the invention, are formed. After forming the flanges, the outer surfaces surrounding the square outer surface are bent such that the bent outer surfaces substantially form an angle of 90 degrees with regard to the square outer surface, with also adjacent bent outer surfaces forming, with regard to each other, an angle of about 90 degrees. The square surface of the case structure that forms in the middle of the thus bent outer surfaces forms the base of the case structure. At least one permanent magnet is placed on the base of the case structure in a desired way, with regard to the bent outer surfaces. The case structure is then preferably filled with elastic, non-absorbing, moisture-proof filling paste, such as epoxy resin or other paste containing two components with both a hardening agent and a polymer. The filling agent, as it hardens, keeps the permanent magnet/s in the desired position and protects the magnets from moisture. The fitting element equipped with corresponding surfaces, namely grooves, for the flanges of the case structure is then fitted to mechanically contact the bent outer surfaces in such a way that the extra filling material in the case structure escapes prior to the contact between the fitting element and the bent outer surfaces. As the fitting element is in preferably mechanical contact with the bent outer surfaces, the flanges in the case structure are preferably bent to the corresponding grooves in the fitting element, so that, when interlocking the case structure and the fitting element, the external dimensions of the case structure and the fitting element remain unchanged.

Interlocking the fitting element and the case structure of the polar element for a permanent magnet according to the invention using flanges or protruding parts and corresponding surfaces is preferably suitable for substantially all wrought metals and substantially all sizes of polar elements for permanent magnets.

### LIST OF FIGURES

In the following, the present invention is described in more detail with reference to the accompanying drawings, in which

FIG. 1 shows a side view of the case structure of a preferred embodiment of the invention,

FIG. 2 shows an oblique top view of the embodiment of FIG. 1,

FIG. 3 shows an oblique top view of the embodiment of FIGS. 1 and 2 with different flanges,

FIG. 4 shows a side view of another preferred embodiment of the invention,

FIG. 5 shows a sectional view of the embodiment of FIG. 4 as seen from above,

FIG. 6 shows an oblique top view of the embodiment of FIG. 4,

FIG. 7 shows a side view of a third preferred embodiment of the invention,

FIG. 8 shows a sectional view of the embodiment of FIG. 7 as seen from above,

FIG. 9 shows an oblique top view of the embodiment of FIG. 7,

FIG. 10 shows still another preferred embodiment of the invention as seen from above, and

FIG. 11 shows the embodiment of FIG. 10 as seen from above with the flanges being set in the bent position.

### DETAILED DESCRIPTION OF THE INVENTION

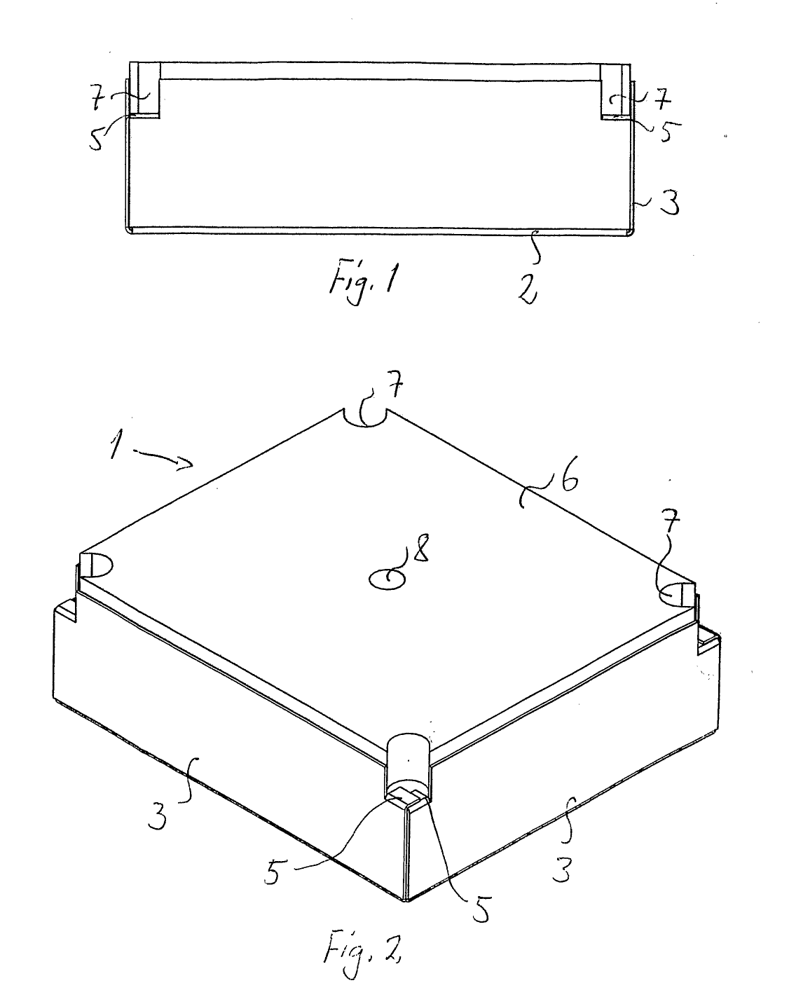

According to FIGS. 1 and 2, the case structure of the polar element 1 for a permanent magnet consists of a base 2 and a side element 3 bent on four different sides of the base 2. Rectangular flanges 5 are formed on the corners of the side elements 3 parting from the base 2, which flanges are bent to partly overlap. A fitting element 6 is set on the upper part of the side elements 3 to seal the case structure 1, with grooves 7 formed on the corners of said fitting element. The grooves 7 are sized such that the flanges 5, when bent, are substantially fully inside the respective grooves 7. Also, a fitting part 8 is shown in the fitting element 6, used for coupling the polar element to the site where it is used.

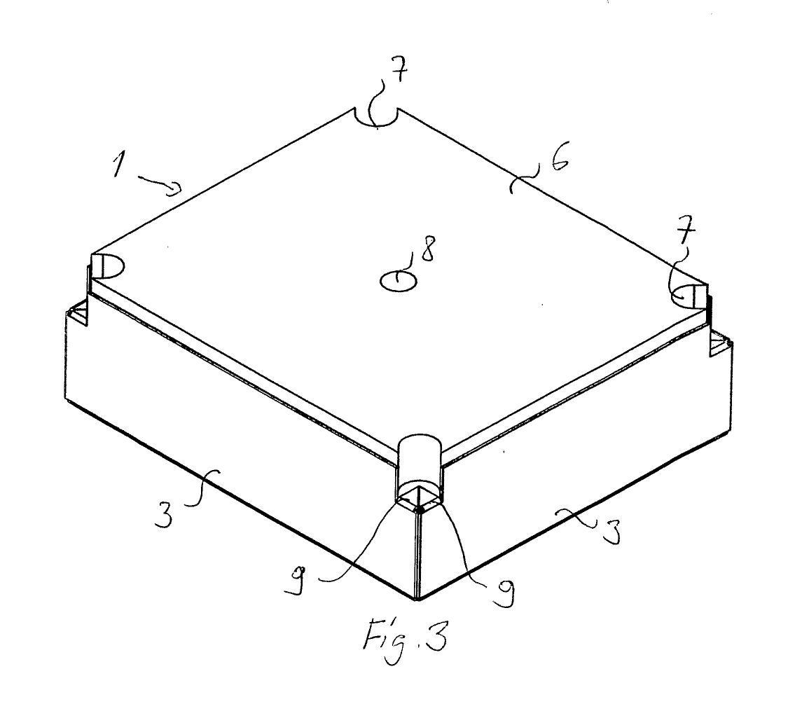

FIG. 3 is analogous to the embodiment of FIGS. 1 and 2, except for the shape of the flanges 9 used for coupling together the base 2 and the fitting element 6, which shape is triangular.

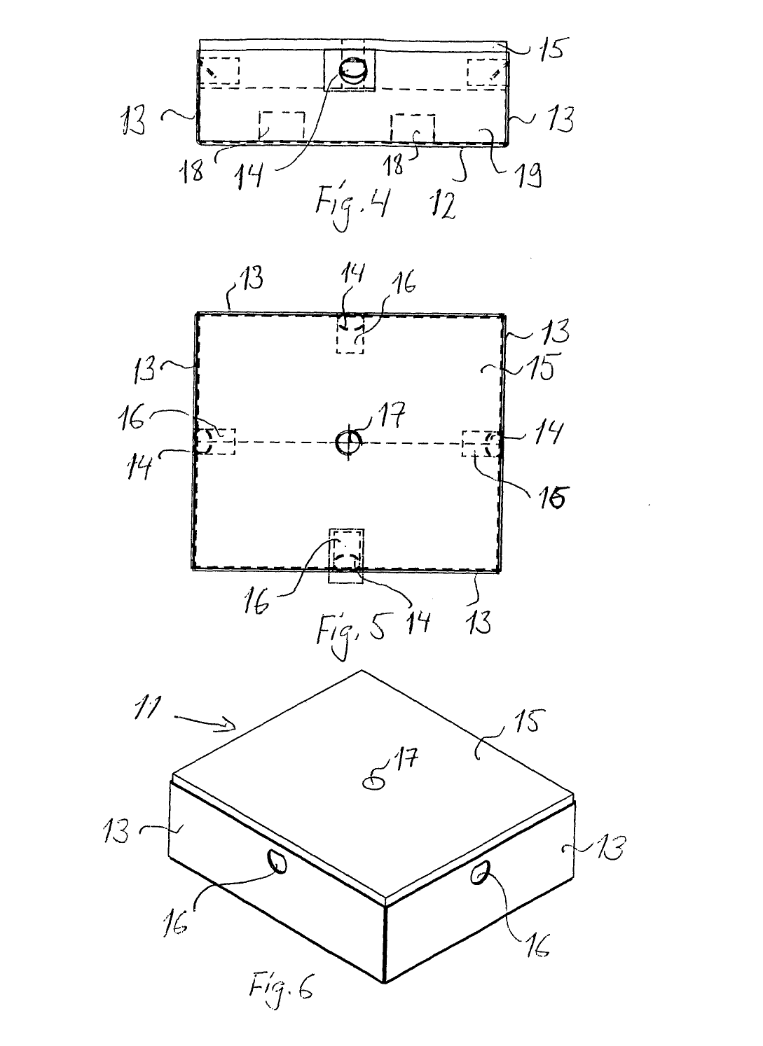

According to FIGS. 4, 5, and 6, the case structure of the polar element 11 consists of a base 12 and a side element 13 bent on four different sides of the base 12. A bendable flange 14 of at least partly circular shape is formed in each side element 13, on the section parting from the corners. Slots 16 formed in the fitting element 15 are illustrated in dashed lines in FIGS. 4 and 5, with flanges 14 bent inside said slots. FIG. 4 also shows, in dashed lines, the magnets 18 of the polar element, and filling material, indicated by reference number 19, surrounding the magnets 18. A fitting part 17 for coupling the polar element to the site where it is used is also shown in the fitting element 15.

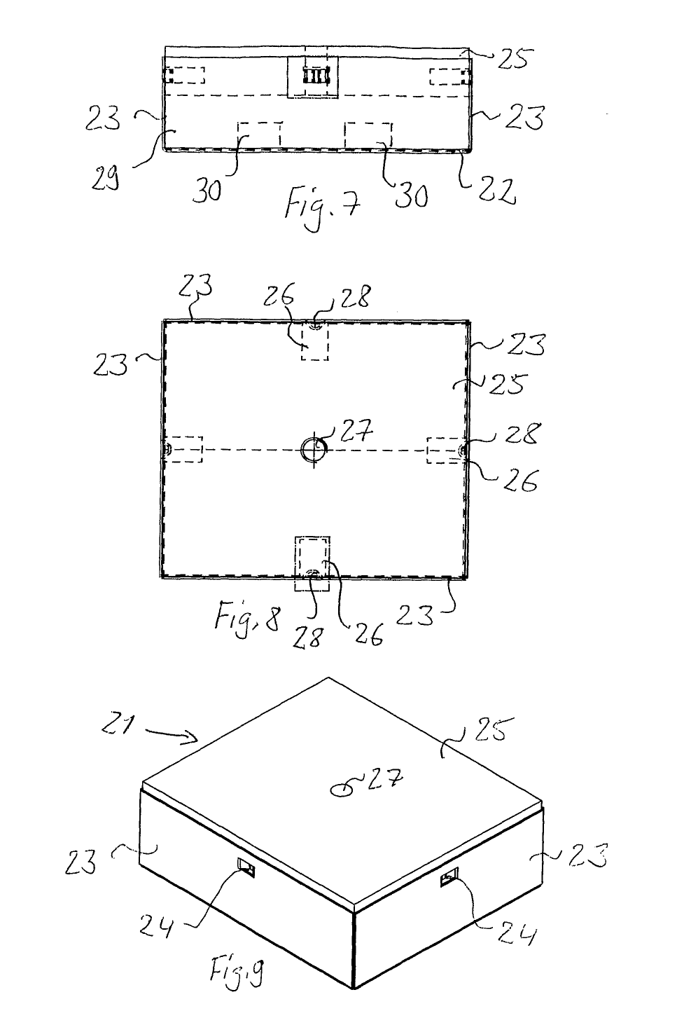

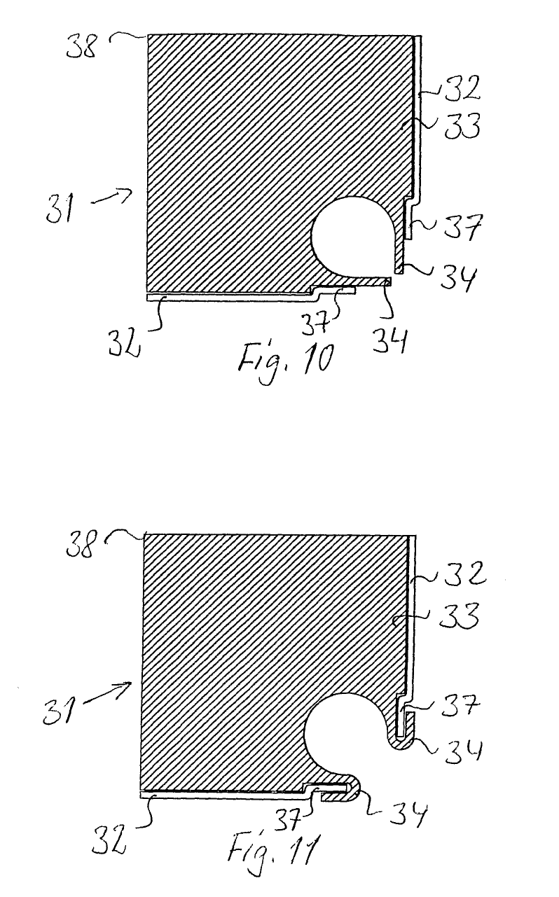

According to FIGS. 7, 8, and 9, the case structure of the polar element 21 consists of a base 22 and a side element 23 bent on four different sides of the base 22. A bendable part 24 of substantially rectangular shape is formed in each side element 23, in the section parting from the corners. Slots 26 formed in the fitting element 25 are illustrated in dashed lines in FIGS. 7 and 8, with a protruding part 28, provided by bending the bendable part, bent inside these slots. FIG. 7 also shows, in dashed lines, the magnets 30 of the polar element, and filling material, indicated by reference number 29, surrounding the magnets 30. A fitting part 27 for coupling the polar element according to the invention to the site where it is used is also shown in the fitting element 25.

FIGS. 10 and 11 show a section of the polar element 31, its case structure 32 and the fitting element 33. Flanges 34 are formed on one corner of the fitting element 33. Grooves 37, corresponding to the flanges 34, are formed on the outer surface of the case structure, in which grooves 37 the flanges 34 are bent according to FIG. 11, the bending direction being, at least partially, outwards from the centre part 38 of the polar element 31. According to FIG. 11, the outer surface of the flanges 34 is flush with the outer surface of the section parting from the grooves 37 of the case structure 32, the flanges 34 thus not increasing the space required by the polar element 31.

1. A polar element for a permanent magnet, containing
at least one permanent magnet,
a case structure (2, 3; 12, 13; 22, 23; 32), inside which said at least one permanent magnet is placed,
a fitting element (6,15,25,33) fitted to be coupled to the case structure to seal the permanent magnet inside a sealed case formed by the case structure and the fitting element, and
filling material inside said case for coupling the permanent magnet to the case structure and/or to the fitting element,
in which polar element, either the case structure or the fitting element is made of ferromagnetic material, the other one being made of nonmagnetic material, characterized in that mechanically bendable flanges and protruding parts (5,14,24,34,35) are formed in the case structure (2, 3;r 12, 13;r 22, 23; 32) and/or the fitting element (6,15,25,33), and corresponding surfaces (7,16,26,36,37) are respectively formed in the fitting element (6,15,25,33) and/or the case structure (2, 3,−12, 13,−22, 23; 32), substantially opposing the flanges or protruding parts (5,14,24,34,35), such that the flanges or protruding parts are bendable to the corresponding surfaces to interlock the case structure and the fitting element such that the flanges or protruding parts (5,14,24,34,35), when bent, remain substantially within the external dimensions of the polar element (1,11,21,31).

2. The polar element according to claim 1, characterized in that at least some of the mechanically bendable flanges or protruding parts (5,14,24,34,35) and the corresponding surfaces (7,16,26,36,37) are formed on the corners nearest to the fitting element (6,15,25,33) of the polar element formed as a rectangular prism.

3. The polar element according to claim 1, characterized in that at least some of the mechanically bendable flanges or protruding parts (5,14,24,34,35) and corresponding surfaces (7,16,26,36,37) are formed on the faces nearest to the fitting element (6,15,25,33) of the polar element formed as a rectangular prism.

4. The polar element according to claim 1, characterized in that at least some of the mechanically bendable flanges or protruding parts (5,14,24,34,35) are formed in the case structure (2, 3; 12, 13,−22, 23;32).

5. The polar element according to claim 1, characterized in that at least some of the mechanically bendable flanges or protruding parts (5,14,24,34,35) are formed in the fitting element (6,15,25,33).

6. The polar element according to claim 1, characterized in that at least some of the mechanically bendable flanges or protruding parts (5,14,24,34,35) are bent at least partly inwards, as seen from the centre part of the polar element (1,11,21,31).

7. The polar element according to claim 1, characterized in that at least some of the mechanically bendable flanges or protruding parts (5,14,24,34,35) are bent at least partly outwards, as seen from the centre part of the polar element (1,11,21,31).

8. The polar element according to claim 1, characterized in that at least some of the mechanically bendable flanges or protruding parts (5,14,24,34,35) are at least partly wedge-shaped.

9. The polar element according to claim 1, characterized in that at least some of the mechanically bendable flanges or protruding parts (5,14,24,34,35) are at least partly circular in shape.

10. The polar element according to claim 1, characterized in that at least some of the mechanically bendable flanges or protruding parts (5,14,24,34,35) are at least partly rectangular in shape.

11. The polar element according to claim 1, characterized in that at least some of the mechanically bendable flanges or protruding parts (5,14,24,34,35) are at least partly triangular in shape.

12. The polar element according to claim 2, characterized in that at least some of the mechanically bendable flanges or protruding parts (5,14,24,34,35) and corresponding surfaces (7,16,26,36,37) are formed on the faces nearest to the fitting element (6,15,25,33) of the polar element formed as a rectangular prism.

13. The polar element according to claim 2, characterized in that at least some of the mechanically bendable flanges or protruding parts (5,14,24,34,35) are formed in the case structure (2, 3; 12, 13,−22, 23;32)

14. The polar element according to claim 3, characterized in that at least some of the mechanically bendable flanges or protruding parts (5,14,24,34,35) are formed in the case structure (2, 3; 12, 13,−22, 23;32).

15. The polar element according to claim 2, characterized in that at least some of the mechanically bendable flanges or protruding parts (5,14,24,34,35) are formed in the fitting element (6,15,25,33).

16. The polar element according to claim 3, characterized in that at least some of the mechanically bendable flanges or protruding parts (5,14,24,34,35) are formed in the fitting element (6,15,25,33).

17. The polar element according to claim 2, characterized in that at least some of the mechanically bendable flanges or protruding parts (5,14,24,34,35) are bent at least partly inwards, as seen from the centre part of the polar element (1,11,21,31).

18. The polar element according to claim 2, characterized in that at least some of the mechanically bendable flanges or protruding parts (5,14,24,34,35) are bent at least partly outwards, as seen from the centre part of the polar element (1,11,21,31).

19. The polar element according to claim 2, characterized in that at least some of the mechanically bendable flanges or protruding parts (5,14,24,34,35) are at least partly wedge-shaped.

20. The polar element according to claim 2, characterized in that at least some of the mechanically bendable flanges or protruding parts (5,14,24,34,35) are at least partly circular in shape.
